(19) United States
(12) Patent Application Publication
(10) Pub. No.: US 2023/0416590 A1
(43) Pub. Date: Dec. 28, 2023

(54) QUATERNARY AMMONIUM SALTS AS PRIMARY VISCOSIFIER FOR INVERT-EMULSION DRILLING FLUIDS

(71) Applicant: Saudi Arabian Oil Company, Dhahran (SA)

(72) Inventors: Vikrant Wagle, Dhahran (SA); Abdullah Saleh Hussain Al-Yami, Dhahran (SA); Ali Mohammed Hussain Al Safran, Dhahran (SA); Khawlah Alanqari, Al Khobar (SA)

(21) Appl. No.: 17/850,363

(22) Filed: Jun. 27, 2022

(51) Int. Cl. C09K 8/36; C09K 8/03

(52) U.S. Cl. CPC C09K 8/36; C09K 8/032

(57) ABSTRACT

Methods for making and using an invert-emulsion drilling fluid, and the invert-emulsion drilling fluid are provided. An exemplary invert-emulsion drilling fluid a quaternary ammonium salt (QAS), an aqueous solvent, a non-aqueous solvent, calcium chloride, and a surfactant.

### TECHNICAL FIELD

The present disclosure is directed to drilling fluids that do not use organophilic clay additives as viscosifiers.

### BACKGROUND

Conventional invert-emulsion drilling fluids employ organophilic clays (organoclay) as the primary viscosifier. However, organoclays degrade with time, failing to maintain the rheological properties of the drilling fluid. Typically, this may be helped by increasing the amounts of organoclay or low gravity solids (LGS) to the drilling fluids. As used herein, low gravity solids are a type of drilling-fluid solid having a lower density than the commonly used barite or hematite that is used to weight up a drilling fluid. The low gravity solids include drill solids plus the added bentonite clay. Overtreatment with organoclay increases the cost of drilling. For example, it may affect other drilling fluid properties, requiring further treatment that adds to the cost. The addition of excess amount of organoclay also increases the plastic viscosity and the solids volume percentage, which lowers the rate of penetration, increasing the cost of drilling.

The changes in drilling fluid rheology that occur with changes in pressure and temperature due to increasing depth of the well will cause changes in the equivalent circulation density (ECD) while drilling. Fluctuations in ECD can lead to fracturing of a formation when operating in a narrow window of pore pressure and fracture gradient, for example, at high reservoir pressure. This can lead to formation damage and mud losses thereby increasing drilling costs. The use of thinner fluids to minimize rheology fluctuations may provide lower ECDs, but the fluid rheology must enable removal of cuttings and assist in suspending drilling solids.

### SUMMARY

An embodiment described in examples herein provides method for preparing an invert-emulsion drilling fluid. The method includes adding a surfactant to a nonaqueous solvent to form an initial mixture, dissolving calcium chloride in water to form a CaCl2 solution, adding the CaCl2 solution to the initial mixture while stirring to form a base mixture, and adding a quaternary ammonium salt (QAS) to the base mixture to form the invert-emulsion drilling fluid.

Another embodiment described in examples herein provides an invert-emulsion drilling fluid. The invert-emulsion drilling fluid includes a quaternary ammonium salt (QAS), an aqueous solvent, a non-aqueous solvent, calcium chloride, and a surfactant.

Another embodiment described in examples herein provides a method for drilling a wellbore with an invert-emulsion drilling fluid. The method includes preparing the invert-emulsion drilling fluid by adding a surfactant to a nonaqueous solvent to form an initial mixture, dissolving calcium chloride in water to form a CaCl2 solution, adding the CaCl2 solution to the initial mixture while stirring to form a base mixture, and adding a quaternary ammonium salt (QAS) to the base mixture to form the invert-emulsion drilling fluid. Drilling fluid additives are added to the invert-emulsion drilling fluid to form a drilling mud. The drilling mud is used to remove cuttings from the wellbore during drilling.

### BRIEF DESCRIPTION OF DRAWINGS

FIG. 1 is a schematic drawing of the drilling of a wellbore using an invert-emulsion drilling fluid that uses a quaternary ammonium salt as a viscosifier.

FIG. 2 is a process flow diagram of a method 200 for drilling a wellbore that uses a quaternary ammonium salt as a viscosifier.

FIGS. 3A to 3C are structures of quaternary ammonium salts that can be used as a viscosifier.

FIG. 4 is a plot comparing the performance of the salt of FIG. 3B to a commercial viscosifier in a clay-free drilling fluid.

FIG. 5 is a plot comparing the performance of the salt of FIG. 3C to a commercial viscosifier in a clay-free drilling fluid and in the presence of low gravity solids.

FIG. 6 is a plot comparing the performance of the salt of FIG. 3C to a commercial viscosifier in a clay-free drilling fluid in the absence of low gravity solids.

FIG. 7 is a schematic diagram of an invert-emulsion drilling fluid showing the interaction of a quaternary ammonium salt and an emulsifier at an interface between a brine droplet and an oil continuous phase.

FIG. 8 is a process flow diagram of a method for testing the static aging of oil-based drilling fluids.

### DETAILED DESCRIPTION

Embodiments described in examples herein are directed to the application of a primary viscosifier, or low-end rheology modifier, for organoclay-free invert-emulsion drilling fluids. As used herein, an invert-emulsion drilling fluid has a continuous phase that is an organic solution, and suspended droplets of an aqueous solution. The low-end rheology modifier is a quaternary ammonium salt. Addition of a quaternary ammonium salt as a primary viscosifier to a 90 pcf (pounds per cubic foot; 1441 kg/m³) organoclay-free invert-emulsion drilling fluid showed a substantial increase in the low shear yield point with a corresponding minimal increase in the plastic viscosity when compared with a 90 pcf organoclay-free invert-emulsion drilling fluid formulated in the absence of the quaternary ammonium salt.

The primary viscosifier described herein provides fluids with low plastic viscosity (PV) that will have minimal impact on the equivalent circulating densities (ECDs) and lead to higher rates-of-penetration (ROPs) while drilling. The viscosifier also gives sufficient low end rheology for good hole cleaning and barite (BaSO₄) sag resistance without the addition of low gravity solids like organoclay. Replacement of organoclay with the organic primary viscosifier can impart flat rheology to the fluid, which is very essential for drilling deep wells where the temperature gradient is high. As used herein, flat rheology describes a material with a viscosity that changes very little (for example, less than about 5%, 10%, or 20%) across a wide strain and temperature range.

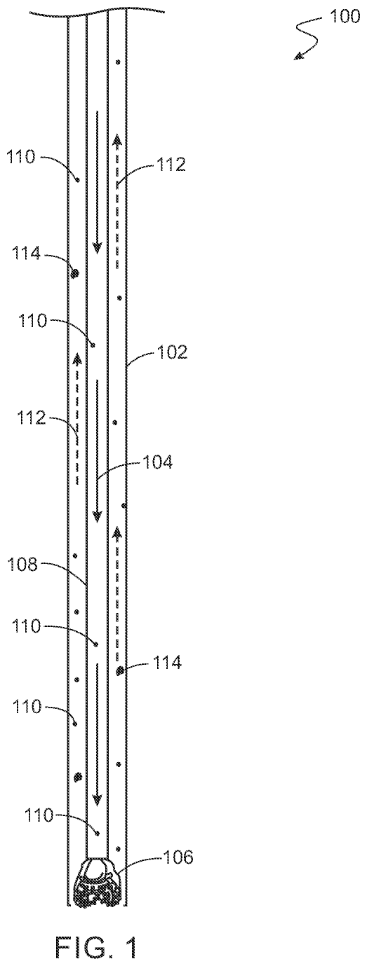

FIG. 1 is a schematic drawing 100 of the drilling of a wellbore 102 using an invert-emulsion drilling fluid 104 that uses a quaternary ammonium salt as a viscosifier. For clarity, not every individual item is labeled. During the drilling, the invert-emulsion drilling fluid 104 is pumped to the drill bit 106 through a drill string 108. In some embodiments, in addition to the quaternary ammonium salt, the invert-emulsion drilling fluid 104 includes barite particles 110 to increase the density of the invert-emulsion drilling fluid 104. In some embodiments, the invert-emulsion drilling fluid 104 includes other materials, such as low gravity solids, for example, Rev Dust™ drilling solids from Haliburton Corp. of Duncan, OK, USA.

In some embodiments, the drill bit 106 is rotated as the drill string 108 is advanced in the wellbore 102, penetrating the subsurface rock formations. In some embodiments, the drill string 108 is not rotated, but a mud motor powered by the flow of the invert-emulsion drilling fluid 104 is used to power the drill bit 106. The invert-emulsion drilling fluid 104, carrying the barite particles 110, flows through the drill bit 106, and is returned to the surface by an upwards flow 112 through the wellbore 102 in the annulus outside of the drill string 108. The upwards flow 112 of the invert-emulsion drilling fluid 104 carries cuttings 114 from the rock face at the bottom of the wellbore 102 back to the surface.

At the surface, the cuttings 114 are separated from the invert-emulsion drilling fluid 104. After separation, the invert-emulsion drilling fluid 104 is recycled to the wellbore 102 to continue the process.

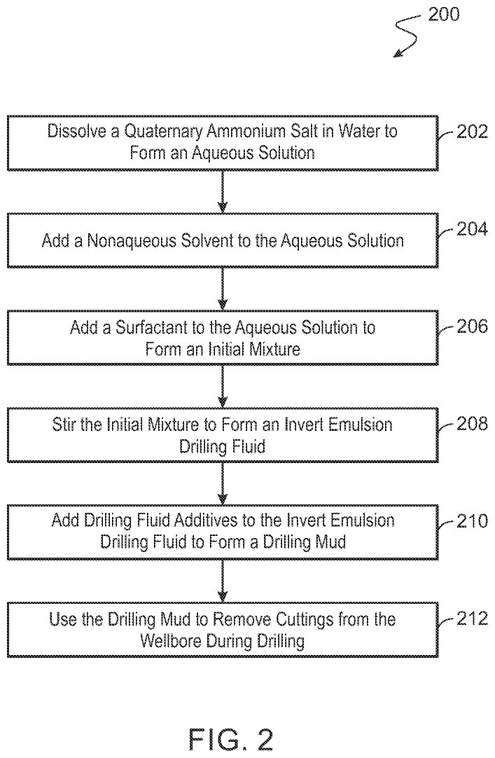

FIG. 2 is a process flow diagram of a method 200 for drilling a wellbore that uses a quaternary ammonium salt as a viscosifier. The method 200 begins at block 202, when a surfactant, or emulsifier, is added to a non-aqueous solvent to form an initial mixture. The surfactant may be an alkyl carboxylic acid, with or without double bonds or branches in the backbone of the alkyl group. The alkyl group may be 6 carbons in length, 12 carbons in length, 18 carbons in length, 24 carbons in length, 30 carbons in length or higher. The alkyl group may include any number of carbons in the chain, which may be selected by the efficacy of the emulsion stabilization. For example, higher numbers of carbons in the backbone of the alkyl group may improve the emulsion stabilization up to a certain point, where higher numbers of carbon beyond that point may result in lower stabilization efficiency due to tangling of the carbon chain. Other types of emulsion stabilizers, such as amides, polyethylene-poly ethylene oxide block copolymers, sulfonates, and the like may be used. The nonaqueous solvent may be diesel oil, mineral oil, or purified mineral oil, or the like.

At block 204, calcium chloride is dissolved in water to form a CaCl₂ solution. The calcium chloride may be added at between about 15 ppb and about 50 ppb, or between about 20 and about 45 ppb, or at about 30 ppb of the final invert-emulsion drilling fluid.

At block 206, the CaCl₂ solution is slowly added to the nonaqueous solution while stirring to form the invert-emulsion drilling fluid. The amount of the CaCl₂ solution is selected by the final volume percentage of nonaqueous solvent to aqueous solvent desired in the drilling fluid. For example, the volume ratio of the nonaqueous solvent to the aqueous solvent may be 95 vol. % to 5 vol. % (95/5), 90/10, 80/20, 70/30, or 60/40.

At block 208, the quaternary ammonium salt is added to the invert-emulsion drilling fluid. The amount of quaternary ammonium salt used depends on the final volume ratio of nonaqueous solvent to aqueous solvent desired in the invert-emulsion drilling fluid. For example, the quaternary ammonium salt may be added to form an invert-emulsion drilling fluid with between 0.5 ppb (pounds per barrel) and 20 ppb of the quaternary ammonium salt, or between about 2 ppb and 10 ppb. In some embodiments, the quaternary ammonium salt is at about 3 ppb.

At block 210, drilling fluid additives are added to the invert-emulsion drilling fluid, for example, to form a drilling mud. The drilling fluid additives can include barite (BaSO₄) or hematite, which are added to adjust the density of the drilling fluid. Other drilling fluid additives that may be used in embodiments include an emulsifier activator to activate the surfactant for forming the invert-emulsion drilling fluid, such as lime (calcium hydroxide) or calcium chloride, among others. In some embodiments, a filtration control agent is added to the invert-emulsion drilling fluid, for example, to reduce fluid loss to permeable zones. Any number of filtration control agents may be used including gelation agents, filter cake formation agents, and the like. While the composition described herein removes the need for organoclay to be added to the invert-emulsion drilling mud for viscosity improvement, organoclay may be used with the other additives described herein. In some embodiments, a friction reducing agent, such as fine drilling dust, is added to lower the solution viscosity during pumping.

At block 212, the drilling mud, including the invert-emulsion drilling fluid with the drilling fluid additives, is pumped through the drill string to the drill bit to remove rock cuttings from the wellbore during the drilling operation. After flowing through the drill bit, the drilling mud flows back up the annulus of the wellbore, for example, outside of the drill string carrying cuttings to the surface. At the surface, the cuttings are separated from the drilling mud, for example, by a settling process, and the separator drilling mud is recycled to the wellbore.

It can be noted that the techniques are not limited to the order of the steps shown. In some embodiments, the surfactant or emulsifier is added to the non-aqueous solvent, before the aqueous and non-aqueous solutions are mixed to form the invert-emulsion drilling fluid.

### Examples

Formulation of Drilling Fluids

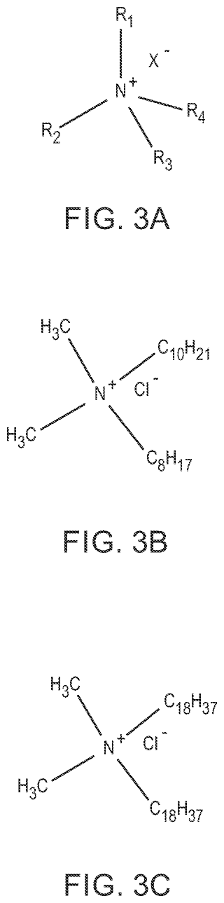

FIGS. 3A to 3C are structures of quaternary ammonium salts that can be used as a viscosifier. The general structure of the quaternary ammonium salts that can be used are shown in FIG. 3A. In this figure, R₁, R₂, and R₃ are each, independently, selected from H, saturated or unsaturated alkyl groups containing C₁ to C₂₂ carbon atoms, aromatic groups, alkyl-aryl heterocyclic groups, sugar groups, and mixtures or combinations thereof. R₄ is an alkyl group containing C₈ to C₂₂ carbon atoms. X is an anion selected from: a chloride anion or other halogen; sulfate ion; nitrate ion; citrate ion; formate ion; phosphate ion; acetate ion; methylsulfonate ion; or para-toluene sulfonate ion; or any combinations thereof.

In various embodiments, the quaternary ammonium salts are ADOGEN 464, shown in FIG. 3B, and ADOGEN 442-100P, shown in FIG. 3C. Both of the quaternary ammonium salts were obtained from Evonik chemicals of Essen, DE. ADOGEN 464 is methyltrialkyl (C8-C10) ammonium chloride (CAS: 72749-59-8) whereas ADOGEN 442-100P is dimethyl dihydrogenated tallow ammonium chloride (CAS: 92129-33-4).

Characterization of Drilling Fluid Rheology

The rheology of the fluid was characterized in terms of PV (plastic viscosity), YP (yield point), and LSYP (low shear yield point). The YP and PV are parameters from the Bingham plastic (BP) rheology model. The YP is determined by extrapolating the BP model to a shear rate of zero. The YP represents the stress used to move the fluid. The YP is expressed in the units of lb./100 ft². The YP indicates the cuttings carrying capacity of the IEF through the annulus, or, in simple terms, the IEFs hole cleaning ability. A YP greater than 15 lb./100 ft² (0.632 Kg/m²) is considered good for drilling. The PV represents the viscosity of a fluid when extrapolated to infinite shear rate, expressed in units of centipoise (cP). The PV indicates the type and concentration of the solids in the IEF, and a low PV is preferred. Both PV and YP are calculated using 300 revolutions per minute (rpm) and 600-rpm shear rate readings on a standard oilfield viscometer as given in Equations 1 and 2 below.

PV=(600 rpm reading)−(300 rpm reading) Eqn. 1

YP=(300 rpm reading)−PV Eqn. 2

The yield stress or Tau₀ is a parameter from the Herschel Buckley (HB) rheology model. The Tau₀ is determined by fitting the HB model to the shear stress versus shear rate curve, which is the viscosity reading plotted against the corresponding rpm as determined on the standard oilfield viscometer. The Tau₀ is expressed in similar units to the YP. The Tau₀ indicates the susceptibility of the IEF to barite sag. For example, a high Tau0 is expected to deliver a sag resistant IEF. The Tau₀ can be estimated reasonably by calculating the LSYP value from Equation 3.

LSYP=[2×(3 rpm reading)]−(6 rpm reading) Eqn. 3

An LSYP equal to or greater than 7 lbs./100 ft² is considered good for drilling.

Formulation of 90 Pcf Organoclay-Free Invert-Emulsion Drilling Fluids with ADOGEN 464

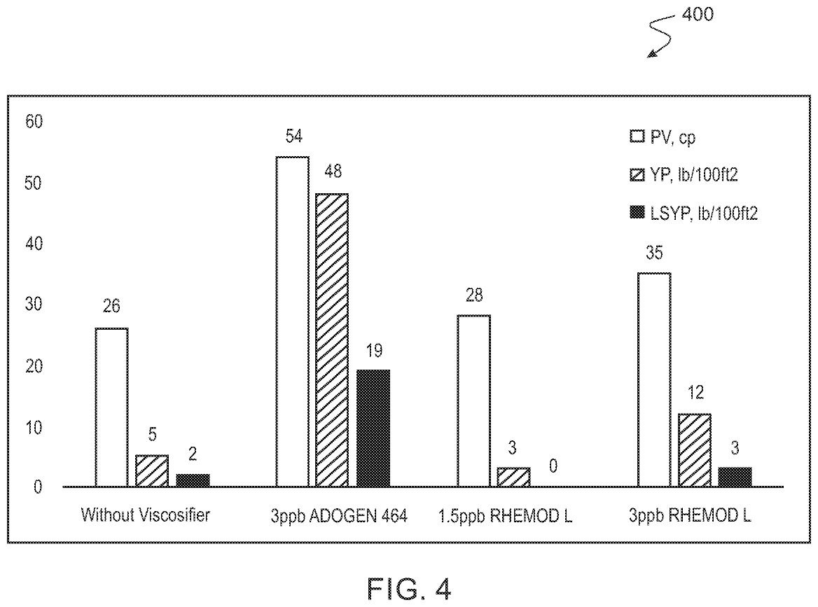

FIG. 4 is a plot 400 comparing the performance of the salt of FIG. 3B to a commercial viscosifier in a clay-free drilling fluid. Table 1 and FIG. 4 show the performance of four different 90 pcf organoclay-free invert-emulsion drilling fluids that were formulated and hot rolled at 250° F. (121° C.) for 16 hours. To perform the hot rolling, the fluid is poured in a stainless steel aging cell. The cell is pressurized to 500 psi (about 3500 Kpa) and is rolled in an oven for 16 hours. After 16 hours, the cell is removed from the oven and is cooled in a water bath. After cooling, the fluid is poured into a mud cup and mixed for 5 min using a multimixer. The tests described below are then performed.

Fluid 1 was formulated in the absence of any viscosifier while Fluid 2 and Fluid 3 were formulated with 1.5 ppb and 3 ppb of a commercial viscosifier Rhemod L. Rhemod L is a commercial viscosifier sold by Halliburton. Fluid 4 with 3 ppb ADOGEN 464 was formulated and its performance as a viscosifier was benchmarked against Fluids 2 and 3.

The mixing of the formulation was performed by combining the ingredients in the order shown in Table 1. The mixing time for each ingredient is also shown. As noted herein, the order may be adjusted from that shown in Table 1.

TABLE 1
Formulation of 90 pcf organoclay-free invert-
emulsion drilling fluids with ADOGEN 464

| | Time, | Fluid | Fluid | Fluid | Fluid |
|---|---|---|---|---|---|
| Formulation no. | min | 1 | 2 | 3 | 4 |
| Diesel, bbl¹ (Base oil) | | 157.2 | 157.2 | 155.8 | 155.8 |
| EZMUL, ppb² (Emulsifier) | 5 | 10 | 10 | 10 | 10 |
| LIME, ppb (Emulsifier | 5 | 1.5 | 1.5 | 1.5 | 1.5 |
| activator) | | | | | |
| ADAPTA, ppb (filtration | 5 | 2.5 | 2.5 | 2.5 | 2.5 |
| control agent) | | | | | |
| CaCl₂, ppb | 5 | 29.3 | 29.3 | 29.3 | 29.3 |
| Water, ppb | | 84.5 | 84.5 | 84.5 | 84.5 |
| Revdust, ppb (drilled solids) | 5 | 20 | 20 | 20 | 20 |
| Barite, ppb (weighting agent) | 10 | 199.2 | 199.1 | 199.1 | 199 |
| ADOGEN 464, ppb (viscosifier) | 5 | — | — | — | 3 |
| Rhemod L, ppb (viscosifier) | 5 | — | 1.5 | 3 | — |
| Hot roll, 250° F. (121° C.), | | | | | |
| 500 psi (3450 Kpa) | | | | | |
| 600 rpm | | 57 | 59 | 82 | 156 |
| 300 rpm | | 31 | 33 | 47 | 102 |
| 200 rpm | | 23 | 23 | 34 | 82 |
| 100 rpm | | 14 | 13 | 20 | 61 |
| 6 rpm | | 4 | 4 | 5 | 25 |
| 3 rpm | | 3 | 3 | 4 | 22 |
| PV, centipoise (cp) | | 26 | 26 | 35 | 54 |
| YP, lbs./100 ft² (0.049 kg/m²) | | 5 | 7 | 12 | 48 |
| LSYP, lbs./100 ft² (0.049 kg/m²) | | 2 | 2 | 3 | 19 |
| 10 sec gel strength, lbs./100 ft² | | 4 | 3 | 5 | 21 |
| (0.049 kg/m²) | | | | | |
| 10 min gel strength, lbs./100 ft² | | 4 | 3 | 5 | 22 |
| (0.049 kg/m²) | | | | | |

¹1 bbl or barrel is 42 gallons, or 191 liters.
²1 ppb is 2.85 Kg/m³

Fluid 1 was the control, and was formulated in the absence of any viscosifier. It gave values for PV, YP and LSYP of 26, 5 and 2 respectively. Fluid 2 formulated in the presence of 1.5 ppb Rhemod L gave a PV, YP and LSYP of 26, 7 and 2 respectively. Fluid 3 formulated in the presence of 3 ppb Rhemod L gave a PV, YP and LSYP of 35, 12 and 3 respectively. Fluid 4 formulated with 3 ppb of ADOGEN 464 gave a PV, YP and LSYP of 54, 48 and 19 respectively. The % increase in PV, YP and LSYP for Fluids 2, 3, and 4 with respect to Fluid 1 is given in Table 2.

TABLE 2
% increase in PV, YP and LSYP for Fluids 2,
3 and 4 with respect to Fluid 1 (control)

| | Fluid 2 | Fluid 3 | Fluid 4 |
|---|---|---|---|
| | (1.5 ppb | (3 ppb | (3 ppb |
| | Rhemod L) | Rhemod L) | ADOGEN 464) |
| PV, cp | 0.0 | 34.6 | 107.7 |
| YP, lbs./100 ft² | 40.0 | 140.0 | 860.0 |
| (0.049 kg/m²) | | | |
| LSYP, lbs./100 ft² | 0.0 | 50.0 | 850.0 |
| (0.049 kg/m²) | | | |

These results show that ADOGEN 464 was able to substantially increase the yield point and low-end rheology (6 and 3 rpm readings) as compared to Rhemod L. For a good drilling fluid, LSYP value (low-end rheology) should be greater or equal to 7 lb./100 ft² (0.342 kg/m²). A high LSYP value for the drilling fluid ensures good hole cleaning and greater barite sag resistance. The high LSYP value for Fluid 4 shows that ADOGEN 464 was able to impart the useful rheological properties to the organoclay-free invert-emulsion drilling fluids.

Formulation of 90 pcf organoclay-free invert-emulsion drilling fluids with ADOGEN 442-100P

Formulation of 90 pcf organoclay-free invert-emulsion drilling fluids in the presence of low gravity solids (Revdust).

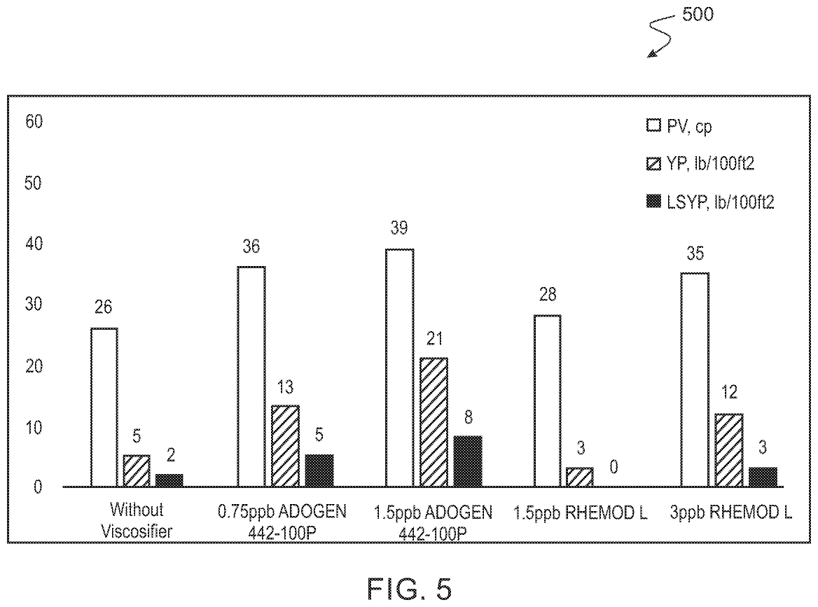

FIG. 5 is a plot 500 comparing the performance of the salt of FIG. 3C to a commercial viscosifier in a clay-free drilling fluid and in the presence of low gravity solids. Table 3 and FIG. 5 show the performance of five different 90 pcf organoclay-free invert-emulsion drilling fluids that were formulated in the presence of Revdust and hot rolled at 250° F. (121° C.) for 16 hours. Fluid 1 was formulated in the absence of any viscosifier while Fluid 2 and Fluid 3 were formulated with 1.5 ppb and 3 ppb of a commercial viscosifier Rhemod L. Fluids 5 and 6 with 0.75 ppb and 1.5 ppb ADOGEN 442-100P respectively were formulated and its performance as a viscosifier was benchmarked against Fluids 2 and 3.

TABLE 3
Formulation of 90 pcf organoclay-free invert-emulsion drilling fluids
with ADOGEN 442-100P in the presence of Revdust (drill solids)

| | Time, | | | | | |
|---|---|---|---|---|---|---|
| Formulation no. | min | Fluid 1 | Fluid 2 | Fluid 3 | Fluid 5 | Fluid 6 |
| Diesel, bbl¹ (Base oil) | | 157.2 | 157.2 | 155.8 | 157.8 | 157.1 |
| EZMUL, ppb² (Emulsifier) | 5 | 10 | 10 | 10 | 10 | 10 |
| LIME, ppb (Emulsifier activator) | 5 | 1.5 | 1.5 | 1.5 | 1.5 | 1.5 |
| ADAPTA, ppb (filtration | 5 | 2.5 | 2.5 | 2.5 | 2.5 | 2.5 |
| control agent) | | | | | | |
| CaCl₂, ppb | 5 | 29.3 | 29.3 | 29.3 | 29.3 | 29.3 |
| Water, ppb | | 84.5 | 84.5 | 84.5 | 84.5 | 84.5 |
| Revdust, ppb (drilled solids) | | 20 | 20 | 20 | 20 | 20 |
| Barite, ppb (weighting agent) | 10 | 199.2 | 199.1 | 199.1 | 199.3 | 199.3 |
| ADOGEN 442 100P, ppb (viscosifier) | 5 | — | — | — | 0.75 | 1.5 |
| Rhemod L, ppb (viscosifier) | 5 | — | 1.5 | 3 | — | — |
| Hot roll, 250° F. (121° C.), 500 psi | | | | | | |
| (3450 KPa) | | | | | | |
| 600 rpm | | 57 | 59 | 82 | 85 | 99 |
| 300 rpm | | 31 | 33 | 47 | 49 | 60 |
| 200 rpm | | 23 | 23 | 34 | 37 | 46 |
| 100 rpm | | 14 | 13 | 20 | 24 | 30 |
| 6 rpm | | 4 | 4 | 5 | 7 | 10 |
| 3 rpm | | 3 | 3 | 4 | 6 | 9 |
| PV, cp | | 26 | 26 | 35 | 36 | 39 |
| YP, lbs./100 ft² (0.049 kg/m²) | | 5 | 7 | 12 | 13 | 21 |
| LSYP, lbs./100 ft² (0.049 kg/m²) | | 2 | 2 | 3 | 5 | 8 |
| 10 sec gel strength, lbs./100 ft² | | 4 | 3 | 5 | 6 | 9 |
| (0.049 kg/m²) | | | | | | |
| 10 min gel strength, lbs./100 ft² | | 4 | 3 | 5 | 7 | 10 |
| (0.049 kg/m²) | | | | | | |
| 30 min gel strength, lbs./100 ft² | | 5 | — | 6 | 9 | 10 |
| (0.049 kg/m²) | | | | | | |

¹1 bbl or barrel is 42 gallons, or 191 liters.
²1 ppb is 2.85 Kg/m³

Fluid 1 (control) formulated in the absence of any viscosifier gave a PV, YP and LSYP of 26, 5 and 2 respectively. Fluid 2 formulated in the presence of 1.5 ppb Rhemod L gave a PV, YP and LSYP of 26, 7 and 2 respectively. Fluid 3 formulated in the presence of 3 ppb Rhemod L gave a PV, YP and LSYP of 35, 12 and 3 respectively. Fluid 5 formulated with 0.75 ppb of ADOGEN 442-100P gave a PV, YP and LSYP of 36, 13 and 5 respectively. Fluid 6 formulated with 1.5 ppb of ADOGEN 442-100P gave a PV, YP and LSYP of 39, 21 and 8 respectively. The % increase in PV, YP and LSYP for Fluids 2, 3, 5 and 6 with respect to Fluid 1 is given in Table 4.

TABLE 4
% increase in PV, YP and LSYP for Fluids 2,
3, 5 and 6 with respect to Fluid 1 (control)

| | Fluid 2 | Fluid 3 | Fluid 5 | Fluid 6 |
|---|---|---|---|---|
| | (1.5 ppb | (3 ppb | (3 ppb | (3 ppb |
| | Rhemod | Rhemod | ADOGEN | ADOGEN |
| | L) | L) | 442) | 442) |
| PV, cp | 0.0 | 34.6 | 38.5 | 50.0 |
| YP, lbs./100 ft² | 40.0 | 140.0 | 160.0 | 320.0 |
| (0.049 kg/m²) | | | | |
| LSYP, lbs./ | 0.0 | 50.0 | 150.0 | 300.0 |
| 100 ft² | | | | |
| (0.049 kg/m²) | | | | |

These results show that ADOGEN 442-100P was able to substantially increase the yield point and low-end rheology (6 and 3 rpm readings) with minimal increase in PV as compared to Rhemod L.

For a good drilling fluid, LSYP value (low-end rheology) should be greater or equal to 7 lb./100 ft² (0.342 kg/m²). A high LSYP value for the drilling fluid ensures good hole cleaning and greater barite sag resistance. The high LSYP value for Fluid 5 and Fluid 6 shows that ADOGEN 442-100P was able to impart the desired rheological properties to the organoclay-free invert-emulsion drilling fluids.

Formulation of 90 pcf organoclay-free invert-emulsion drilling fluids in the absence of low gravity solids (RevDust).

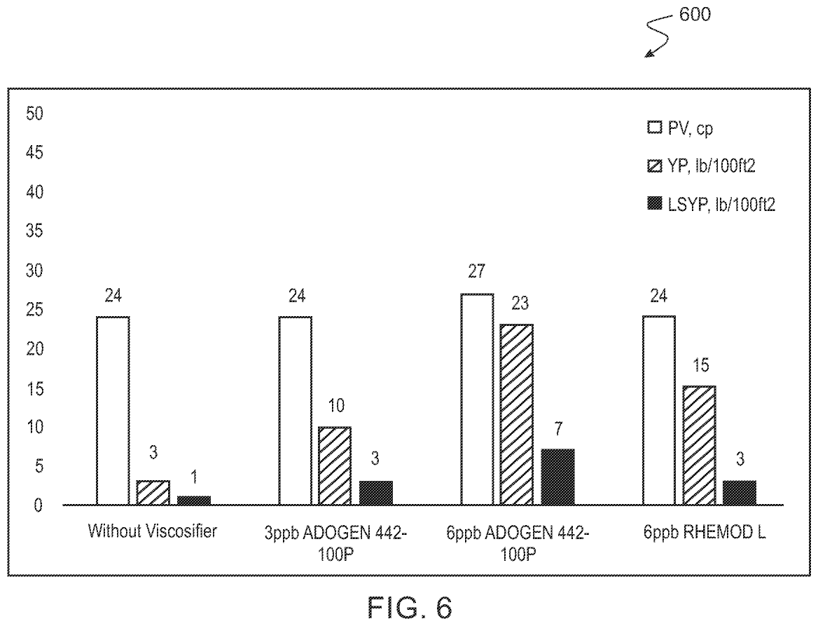

FIG. 6 is a plot 600 comparing the performance of the salt of FIG. 3C to a commercial viscosifier in a clay-free drilling fluid in the absence of low gravity solids. Table 5 and FIG. 6 shows the performance of four different 90 pcf organoclay-free invert-emulsion drilling fluids that were formulated in the absence of low gravity solids (Revdust) and hot rolled at 250° F. (121° C.) for 16 hours. Fluid 7 (control) was formulated in the absence of any viscosifier while Fluid 8 and Fluid 9 were formulated with 3 ppb and 6 ppb of ADOGEN 442-100P respectively. Fluid 10 with 6 ppb of commercial viscosifier Rhemod L was formulated and its performance as a viscosifier was benchmarked against Fluids 8 and 9.

TABLE 5
Formulation of 90 pcf organoclay-free invert-emulsion drilling fluids
with ADOGEN 442-100P in the absence of Revdust (drill solids)

| | Time | Fluid | Fluid | Fluid | Fluid |
|---|---|---|---|---|---|
| Formulation no. | min | 7 | 8 | 9 | 10 |
| Diesel, bbl¹ (Base oil) | | 160.9 | 158 | 154.9 | 155.6 |
| EZMUL, ppb² (Emulsifier) | 5 | 10 | 10 | 10 | 10 |
| LIME, ppb (Emulsifier activator) | 5 | 1.5 | 1.5 | 1.5 | 1.5 |
| ADAPTA, ppb (filtration control | 5 | 2.5 | 2.5 | 2.5 | 2.5 |
| agent) | | | | | |
| CaCl₂, ppb | 5 | 29.8 | 29.8 | 29.8 | 29.8 |
| Water, ppb | | 85.7 | 85.7 | 85.7 | 85.8 |
| Barite, ppb (weighting agent) | 10 | 215.2 | 215.2 | 211.8 | 214.5 |
| ADOGEN 442 100P, ppb | 5 | — | 3 | 6 | — |
| (viscosifier) | | | | | |
| Rhemod L, ppb (viscosifier) | 5 | — | — | — | 6 |

Hot roll, 250° F., 500 psi (3450 KPa)

| | | | | | |
|---|---|---|---|---|---|
| 600 | rpm | 51 | 58 | 77 | 63 |
| 300 | rpm | 27 | 34 | 50 | 39 |
| 200 | rpm | 20 | 26 | 40 | 27 |
| 100 | rpm | 12 | 17 | 28 | 16 |
| 6 | rpm | 3 | 5 | 9 | 5 |
| 3 | rpm | 2 | 4 | 8 | 4 |

| | | | | |
|---|---|---|---|---|
| PV, cp | 24 | 24 | 27 | 24 |
| YP, lbs./100 ft² (0.049 kg/m²) | 3 | 10 | 23 | 15 |
| LSYP, lbs./100 ft² (0.049 kg/m²) | 1 | 3 | 7 | 3 |
| 10 sec gel strength, lbs./100 ft² | 2 | 5 | 7 | 5 |
| (0.049 kg/m²) | | | | |
| 10 min gel strength, lbs./100 ft² | 3 | 11 | 7 | 6 |
| (0.049 kg/m²) | | | | |
| 30 min gel strength, lbs./100 ft² | 3 | — | 10 | — |
| (0.049 kg/m²) | | | | |

¹1 bbl or barrel is 42 gallons, or 191 liters.
²1 ppb or pound per barrel is 2.85 Kg/m³

Fluid 7 (control) formulated in the absence of any viscosifier gave a PV, YP and LSYP of 24, 3 and 1 respectively. Fluid 8 formulated in the presence of 3 ppb ADOGEN 442-100P gave a PV, YP and LSYP of 24, 10 and 3 respectively. Fluid 9 formulated in the absence of 6 ppb ADOGEN 442-100P gave a PV, YP and LSYP of 27, 23 and 7 respectively. Fluid 10 formulated with 6 ppb of Rhemod L gave a PV, YP and LSYP of 24, 15 and 3 respectively. The % increase in PV, YP and LSYP for Fluids 8, 9 and 10 with respect to Fluid 7 is given in Table 6.

TABLE 6
% increase in PV, YP and LSYP for Fluids 8,
9 and 10 with respect to Fluid 7 (control)

| | Fluid 8 | Fluid 9 | Fluid 10 |
|---|---|---|---|
| | (3 ppb | (6 ppb | (6 ppb |
| | ADOGEN | ADOGEN | Rhemod |
| | 442-100P) | 442-100P) | L) |
| PV, cp | 0.0 | 12.5 | 0.0 |
| YP, lbs./100 ft² | 233.3 | 666.7 | 400.0 |
| (0.049 kg/m²) | | | |
| LSYP, lbs./100 ft² | 200.0 | 600.0 | 200.0 |
| (0.049 kg/m²) | | | |

These results show that ADOGEN 442-100P was able to substantially increase the yield point and low-end rheology (6 and 3 rpm readings) with minimal increase in PV as compared to Rhemod L.

For a good drilling fluid, LSYP value (low-end rheology) should be greater or equal to 7 lb./100 ft² (0.342 kg/m²). The high LSYP value for Fluid 9 as compared to Fluid 10 shows that ADOGEN 442-100P was able to impart the desired rheological properties to the organoclay-free invert-emulsion drilling fluids.

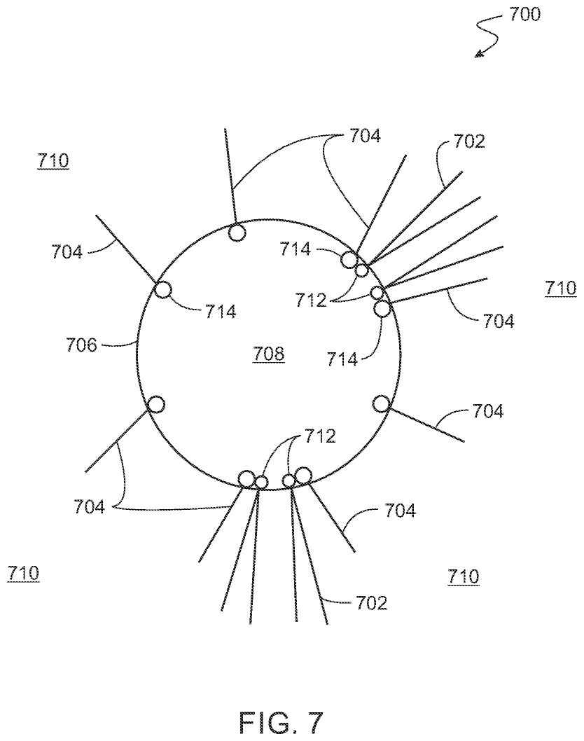

FIG. 7 is a schematic diagram of an invert-emulsion drilling fluid 700 showing the interaction of a quaternary ammonium salt (QAS) 702 and an emulsifier 704 at an interface 706 between a brine droplet 708 and an oil continuous phase 710. A possible explanation for enhanced rheology for organoclay free, invert-emulsion drilling fluid 700 using a QAS 702 is shown in FIG. 7.

The QAS 702 has a positive charge on the nitrogen group 712. The emulsifier 704 that is typically used to formulate an invert-emulsion in the invert-emulsion drilling fluid 700 is a long chain compound with a carboxylic group 714. Lime, which is added to the drilling fluid forms a calcium salt of emulsifier. Both the emulsifier 704 and QAS 702 are amphiphilic in nature, having they both have polar and non-polar groups. The polar COO⁻ carboxylate group 714 of the emulsifier 704 and the polar NH₃⁺ moiety of the nitrogen group 712 of the QAS 702 would have an affinity for the aqueous phase of the brine droplet 708, whereas the non-polar group of the emulsifier 704 and C-36 non-polar group of the dimer diamine have an affinity for the hydrocarbon or oil phase of the oil continuous phase 710.

The oppositely charged COO⁻ carboxylate group 714 and NH₃⁺ group 712 of the emulsifier 704 and QAS 702, respectively, will have strong interaction between them, which may lead to better packing of the emulsifier 704 and QAS 702 at the interface 706 between the oil and brine phases of the invert-emulsion drilling fluid 700. Better packing of the molecules would result in lower interfacial tension between the oil continuous phase 710 and the brine droplet 708, leading to brine droplets that are both smaller and more stable. That will increase the rheology performance of the invert-emulsion drilling fluid 700.

Static Aging Studies of 90 pcf Organoclay-Free Invert-Emulsion Drilling Fluids Formulated with 1.5 Ppb ADOGEN 442-100P

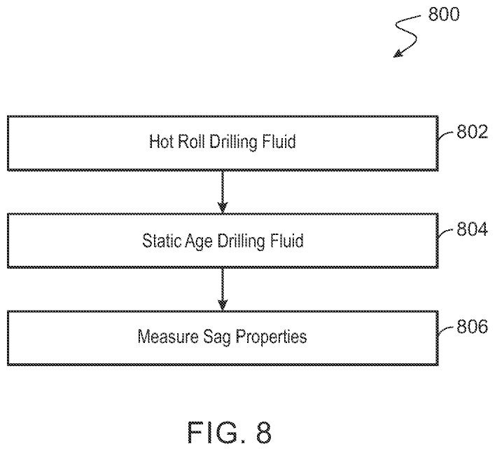

Static aging studies were performed on the 90 pcf organoclay-free invert-emulsion drilling fluids formulated with 6 ppb CDDH (Fluid 3) and 6 ppb Rhemod L (Fluid 4) respectively to determine the sag-resistance of the fluid, over time. FIG. 8 is a process flow diagram of a method 800 for testing the static aging of oil-based drilling fluids. The method 800 begins at block 802, with hot rolling the drilling fluid. To perform this, the 90 pcf fluid was mixed in a stainless steel mixing cup using a five-spindle multimixer. The fluid was then aged in a high-temperature, high-pressure (HPHT) stainless steel (SS) aging cell in a hot rolling oven at 250° F. (121° C.) for 16 hours.

At block 804, the drilling fluid was static aged. After hot rolling, the HTHP SS aging cell was cooled and the fluid was then mixed on the multimixer for 5 min and then subsequently placed again in the aging cell. The aging cell was then set to 500 psi (3450 KPa) of pressure and placed in a mechanical convection oven at a desired temperature and duration. For the tests described here, the temperature of the oven was set to 121° C. (250° F.) for the aging, and the aging was run for 16 hours.

At block 806, the sag performance of the fluid was assessed by determining the sag factor. The specific gravity of the top (SGₜₒₚ) and bottom (SG_{bottom}) portion of the fluid in the aging cell were determined by drawing 10 ml aliquots and measuring their weights on an analytical balance. The sag factor for the static aged fluid was then calculated using the formula in Equation 4:

$$SagFactor = \frac{{SG}_{bottom}}{{SG}_{bottom} + {SG}_{top}} \qquad EQN . 4$$

In Equation 4, SG_{bottom} is the density of the fluid at the bottom of the aging cell, and SGₜₒₚ is the density of the fluid at the top of the aging cell. Generally, a sag factor greater than implies that the fluid has potential to sag, i.e., allow solids to settle.

Fluid 6 formulated with 1.5 ppb ADOGEN 442-100P on static aging gave a sag factor of 0.517 while Fluid 2 formulated with 1.5 ppb Rhemod L gave a sag factor of A sag factor of 0.517 implies that the fluid is resistant to barite sag. Fluid 6 formulated with ADOGEN 442-100P gave a lower sag factor as compared with Fluid 2 formulated with Rhemod L. This showed that ADOGEN 442-100P imparts better sag resistance as compared to the commercially available Rhemod L.

### Embodiments

An embodiment described in examples herein provides method for preparing an invert-emulsion drilling fluid. The method includes adding a surfactant to a nonaqueous solvent to form an initial mixture, dissolving calcium chloride in water to form a CaCl₂ solution, adding the CaCl₂ solution to the initial mixture while stirring to form a base mixture, and adding a quaternary ammonium salt (QAS) to the base mixture to form the invert-emulsion drilling fluid.

In an aspect, the QAS has the structure:

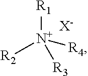

wherein R₁, R₂, and R₃ are each independently selected from H; saturated or unsaturated alkyl groups containing C₁ to C₂₂ carbon atoms; aromatic groups; alkyl-aryl, heterocyclic groups; sugar groups; and mixtures or combinations thereof; R₄ is an alkyl group containing C₈ to C₂₂ carbon atoms; and X is an anion selected from: a chloride anion or other halogen; sulfate ion; nitrate ion; citrate ion; formate ion; phosphate ion; acetate ion; methylsulfonate ion; or para-toluene sulfonate ion; or any combinations thereof.

In an aspect, the QAS has the structure:

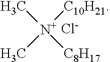

In an aspect, the QAS has the structure:

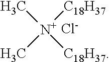

In an aspect, the method includes adding barium sulfate to the invert-emulsion drilling fluid.

In an aspect, the method includes adding an organoclay to the invert-emulsion drilling fluid.

In an aspect, the method includes adding a filtration control agent to the invert-emulsion drilling fluid.

Another embodiment described in examples herein provides an invert-emulsion drilling fluid. The invert-emulsion drilling fluid includes a quaternary ammonium salt (QAS), an aqueous solvent, a non-aqueous solvent, calcium chloride, and a surfactant.

In an aspect, the QAS has the structure:

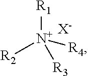

wherein R₁, R₂, and R₃ are each independently selected from H; saturated or unsaturated alkyl groups containing C₁ to C₂₂ carbon atoms; aromatic groups; alkyl-aryl, heterocyclic groups; sugar groups; and mixtures or combinations thereof; R₄ is an alkyl group containing C₈ to C₂₂ carbon atoms; and X is an anion selected from: a chloride anion or other halogen; sulfate ion; nitrate ion; citrate ion; formate ion; phosphate ion; acetate ion; methylsulfonate ion; or para-toluene sulfonate ion; or any combinations thereof.

In an aspect, the QAS has the structure:

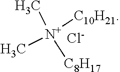

In an aspect, the QAS has the structure:

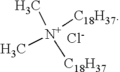

In an aspect, the invert-emulsion drilling fluid includes between about 5 vol. % water and about 45 vol. % water.

In an aspect, the invert-emulsion drilling fluid includes between about 95 vol. % of a non-aqueous solvent and about 55 vol. % of the non-aqueous solvent.

In an aspect, the non-aqueous solvent includes mineral oil.

In an aspect, the non-aqueous solvent includes diesel oil.

In an aspect, the surfactant includes an alkyl carbonate.

In an aspect, the invert-emulsion drilling fluid includes a filtration control agent.

In an aspect, the invert-emulsion drilling fluid includes barium sulfate.

Another embodiment described in examples herein provides a method for drilling a wellbore with an invert-emulsion drilling fluid. The method includes preparing the invert-emulsion drilling fluid by adding a surfactant to a nonaqueous solvent to form an initial mixture, dissolving calcium chloride in water to form a CaCl₂ solution, adding the CaCl₂ solution to the initial mixture while stirring to form a base mixture, and adding a quaternary ammonium salt (QAS) to the base mixture to form the invert-emulsion drilling fluid. Drilling fluid additives are added to the invert-emulsion drilling fluid to form a drilling mud. The drilling mud is used to remove cuttings from the wellbore during drilling.

In an aspect, the QAS has the structure:

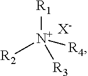

wherein R₁, R₂, and R₃ are each independently selected from H; saturated or unsaturated alkyl groups containing C₁ to C₂₂ carbon atoms; aromatic groups; alkyl-aryl, heterocyclic groups; sugar groups; and mixtures or combinations thereof; R₄ is an alkyl group containing C₈ to C₂₂ carbon atoms; and X is an anion selected from: a chloride anion or other halogen; sulfate ion; nitrate ion; citrate ion; formate ion; phosphate ion; acetate ion; methylsulfonate ion; or para-toluene sulfonate ion; or any combinations thereof.

In an aspect, the QAS has the structure:

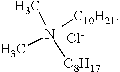

In an aspect, the QAS has the structure:

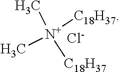

In an aspect, the method includes pumping the drilling mud through a drill string to a drill bit disposed at the end of the drill string, flowing the drilling mud through the drill bit during drilling, and carrying cuttings to the surface in the drilling mud.

In an aspect, the method includes removing the cuttings from the drilling mud, and recycling the drilling mud to the drill string.

Other implementations are also within the scope of the following claims.

1. A method for preparing an invert-emulsion drilling fluid, comprising:
adding a surfactant to a nonaqueous solvent to form an initial mixture;
dissolving calcium chloride in water to form a CaCl₂ solution;
adding the CaCl₂ solution to the initial mixture while stirring to form a base mixture; and
adding a quaternary ammonium salt (QAS) to the base mixture to form the invert-emulsion drilling fluid, wherein the invert-emulsion drilling fluid does not comprise organoclay, and wherein the invert-emulsion drilling fluid comprises between 0.5 ppb (pounds per barrel) and 20 ppb of the quaternary ammonium salt.

2. The method of claim 1, wherein the QAS has the structure: 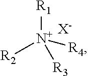
wherein R₁, R₂, and R₃ are each independently selected from H; saturated or unsaturated alkyl groups containing C₁ to C₂₂ carbon atoms; aromatic groups; alkyl-aryl, heterocyclic groups; sugar groups; and mixtures or combinations thereof; R₄ is an alkyl group containing C₈ to C₂₂ carbon atoms; and X is an anion selected from: a chloride anion or other halogen; sulfate ion; nitrate ion; citrate ion; formate ion; phosphate ion; acetate ion; methylsulfonate ion; or para-toluene sulfonate ion; or any combinations thereof.

3. The method of claim 1, wherein the QAS has the structure:

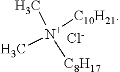

4. The method of claim 1, wherein the QAS has the structure:

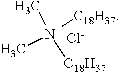

5. The method of claim 1, comprising adding barium sulfate to the invert-emulsion drilling fluid.

6. (canceled)

7. The method of claim 1, comprising adding a filtration control agent to the invert-emulsion drilling fluid.

8. An invert-emulsion drilling fluid, comprising:
a quaternary ammonium salt (QAS);
an aqueous solvent;
a non-aqueous solvent;
calcium chloride; and
a surfactant.

9. The invert-emulsion drilling fluid of claim 8, wherein the QAS has the structure: 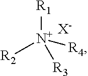
wherein R₁, R₂, and R₃ are each independently selected from H; saturated or unsaturated alkyl groups containing C₁ to C₂₂ carbon atoms; aromatic groups; alkyl-aryl, heterocyclic groups; sugar groups; and mixtures or combinations thereof; R₄ is an alkyl group containing C₈ to C₂₂ carbon atoms; and X is an anion selected from: a chloride anion or other halogen; sulfate ion; nitrate ion; citrate ion; formate ion; phosphate ion; acetate ion; methylsulfonate ion; or para-toluene sulfonate ion; or any combinations thereof.

10. The invert-emulsion drilling fluid of claim 8, wherein the QAS has the structure:

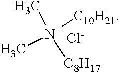

11. The invert-emulsion drilling fluid of claim 8, wherein the QAS has the structure:

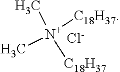

12. The invert-emulsion drilling fluid of claim 8, comprising between about 5 vol. % water and about 45 vol. % water.

13. The invert-emulsion drilling fluid of claim 8, comprising between about 95 vol. % of a non-aqueous solvent and about 55 vol. % of the non-aqueous solvent.

14. The invert-emulsion drilling fluid of claim 8, wherein the non-aqueous solvent comprises mineral oil.

15. The invert-emulsion drilling fluid of claim 8, wherein the non-aqueous solvent comprises diesel oil.

16. The invert-emulsion drilling fluid of claim 8, wherein the surfactant comprises an alkyl carbonate.

17. The invert-emulsion drilling fluid of claim 8, comprising a filtration control agent.

18. The invert-emulsion drilling fluid of claim 8, comprising barium sulfate.

19. A method for drilling a wellbore with an invert-emulsion drilling fluid, comprising:
preparing the invert-emulsion drilling fluid by:
adding a surfactant to a nonaqueous solvent to form an initial mixture;
dissolving calcium chloride in water to form a CaCl₂ solution;
adding the CaCl₂ solution to the initial mixture while stirring to form a base mixture; and
adding a quaternary ammonium salt (QAS) to the base mixture to form the invert-emulsion drilling fluid;
adding drilling fluid additives to the invert-emulsion drilling fluid to form a drilling mud; and
using the drilling mud to remove cuttings from the wellbore during drilling.

20. The method of claim 19, wherein the QAS has the structure: 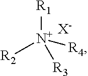
wherein R₁, R₂, and R₃ are each independently selected from H; saturated or unsaturated alkyl groups containing C₁ to C₂₂ carbon atoms; aromatic groups; alkyl-aryl, heterocyclic groups; sugar groups; and mixtures or combinations thereof; R₄ is an alkyl group containing C₈ to C₂₂ carbon atoms; and X is an anion selected from: a chloride anion or other halogen; sulfate ion; nitrate ion; citrate ion; formate ion; phosphate ion; acetate ion; methylsulfonate ion; or para-toluene sulfonate ion; or any combinations thereof.

21. The method of claim 19, wherein the QAS has the structure:

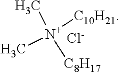

22. The method of claim 19, wherein the QAS has the structure:

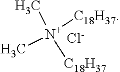

23. The method of claim 19, comprising:
pumping the drilling mud through a drill string to a drill bit disposed at the end of the drill string;
flowing the drilling mud through the drill bit during drilling; and
carrying cuttings to the surface in the drilling mud.

24. The method of claim 23, comprising:
removing the cuttings from the drilling mud; and
recycling the drilling mud to the drill string.
